(19) United States
(12) Patent Application Publication
(10) Pub. No.: US 2009/0094230 A1
(43) Pub. Date: Apr. 9, 2009

(54) RELATED INFORMATION PROVIDING APPARATUS AND PROVIDING METHOD

(76) Inventors: Masayuki SAKATA, Matsudo (JP); Kenya NISHIKI, Chigasaki (JP); Maki MORI, Kawasaki (JP); Erika TANAKA, Yokohama (JP)

Correspondence Address: MCDERMOTT WILL & EMERY LLP, 600 13TH STREET, N.W., WASHINGTON, DC, 20005-3096, US

(21) Appl. No.: 12/210,611

(22) Filed: Sep. 15, 2008

(30) Foreign Application Priority Data
Oct. 5, 2007 (JP) 2007-261466

(51) Int. Cl. G06F 17/30

(52) U.S. Cl. 707/5; 707/E17.074

(57) ABSTRACT

Related information of a content is provided quickly.

A meta-information collection part 12 of a related information providing server 10 periodically collects Electronic Program Guide information as meta-data of a broadcast program from an Electronic Program Guide distribution station 70. A keyword extraction part 13 extracts keywords from the Electronic Program Guide information. A related information acquisition part 14 acquires related information that includes the keyword from a search apparatus 50, and associates the related information with the keyword and stores them in a cache memory 28. When a related information providing part 15 receives a search request with keywords for related information from a user terminal 30, the related information providing part 15 extracts related information corresponding to the keyword among the information stored in the cache memory 28, and sends the extracted information to the user terminal 30.

### INCORPORATION BY REFERENCE

This application claims priority based on a Japanese patent application, No. 2007-261466 filed on Oct. 5, 2007, the entire contents of which are incorporated herein by reference.

### BACKGROUND OF THE INVENTION

The present invention relates to a related information providing apparatus for providing related information of various contents provided to a user and a method of providing related information.

Recently, the fusion of broadcasting and the Internet is proceeding, and one sees a product of an image display unit, such as a TV for receiving a broadcast, to which a function of accessing the Internet is added. Conversely, one sees a product of a terminal, such as a personal computer, that can access the Internet and, in addition, receive a broadcast.

A user of such a product sees a broadcast program and searches for information related to the broadcast program by using the Internet accessing function.

As such an image display unit for providing related information of contents of a broadcast program or the like to a user, there is an apparatus described in Japanese Unexamined Patent Application Laid-Open No. 2005-115790 (hereinafter, referred to as Document 1).

This apparatus receives and displays a broadcast program, while extracts and displays a plurality of keywords related to the broadcast program. When a user selects some keyword, the apparatus searches for information related to the keyword by using a search engine on the network, and displays information obtained by the search.

### SUMMARY OF THE INVENTION

Although a user can readily obtain related information of contents according to the technique described in the above Document 1, there is a problem that it takes time to display the related information of the contents since the user selects keywords, makes a search using the keywords, and then display the information obtained by the search.

The present invention notices the problem of the conventional technique, and provides a related information providing apparatus that can quickly provide related information of contents to a user.

To solve the above problem, the present invention provides a related information providing apparatus comprising:

a meta-information collection means, which collects meta-information of the various contents;

a keyword extraction means, which extracts one or more keywords from the meta-information collected by the meta-information collection means;

a related information acquisition means, which uses, as a search key or search keys, the one or more keywords extracted by the keyword extraction means, to acquire related information that relates to the contents and includes the keywords;

a related information storing means, which stores the related information acquired by the related information acquisition means, in association with the keywords used for acquisition of the related information; and

a related information providing means, which, on receiving a related information request including one or more keywords relating, extracts related information associated with the keywords included in the related information request among related information stored in the related information storing means, and provides the extracted related information.

Further, to solve the above problem, the present invention provides a related information providing method, wherein a computer executes:

a meta-information collection step, in which meta-information of various contents is collected;

a keyword extraction step, in which one or more keywords are extracted from the meta-information collected in the meta-information collection step;

a related information acquisition step, in which the one or more keywords extracted in the keyword extraction step are used as search keys, to acquire related information that includes the keywords relating to a content, and the acquired related information is associated with the keywords and stored in a storage area of the computer; and

when a related information request including one or more keywords relating to a content is received, pieces of related information associated with the keywords included in the related information request are extracted among pieces of related information stored in the storage area, and the extracted pieces of related information are provided.

According to the present invention, before a search request for related information of user's content is made, pieces of related information that will be targets of search requests with a high probability are accumulated. Thus, related information requested by a user can be quickly provided to the user.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a block diagram showing a related information providing system in a first embodiment according to the present invention;

FIG. 2 is an explanatory diagram showing a data structure of a related information table in the first embodiment of the present invention;

FIG. 3 is an explanatory diagram showing a data structure of Electronic Program Guide information;

FIG. 4 is a sequence diagram showing periodic related information acquisition processing in the first embodiment of the present invention;

FIG. 5 is a sequence diagram showing processing from request for related information until provision of the related information in the first embodiment of the present invention;

FIG. 6 is a sequence diagram showing the continuation of the sequence of FIG. 5;

FIG. 7 is a block diagram showing a related information providing system in a second embodiment according to the present invention;

FIG. 8 is an explanatory view showing a data structure of a personal related information table in the second embodiment of the present invention;

FIG. 9 is an explanatory view showing a data structure of a user table in the second embodiment of the present invention;

FIG. 10 is an explanatory view showing a data structure of an apparatus information table in the second embodiment of the present invention;

FIG. 11 is an explanatory view showing a data structure of a federated login table in the second embodiment of the present invention;

FIG. 12 is a sequence diagram showing recorded program related information acquisition processing in the second embodiment of the present invention;

FIG. 13 is a block diagram showing a related information providing system in a third embodiment according to the present invention;

FIG. 14 is a sequence diagram showing periodic related information acquisition processing in the third embodiment of the present invention; and

FIG. 15 is a sequence diagram showing related information providing processing in the third embodiment of the present invention.

### DETAILED DESCRIPTION OF THE EMBODIMENTS

Now, embodiments of a related information providing system according to the present invention will be described referring to the figures.

### First Embodiment

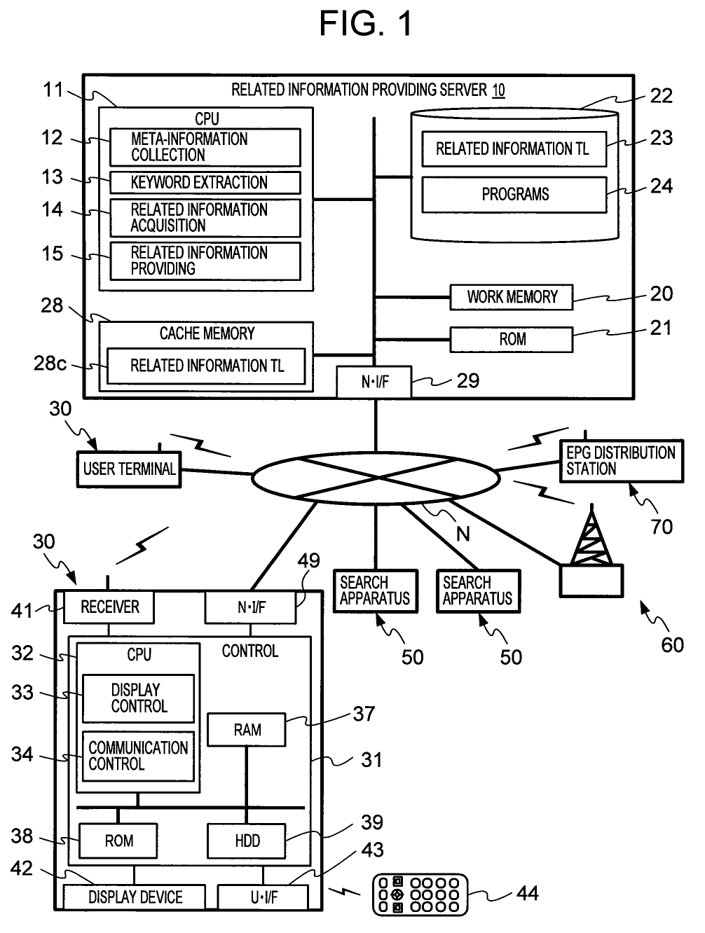

First, referring to FIGS. 1-6, a first embodiment of a related information providing apparatus according to the present invention will be described.

As shown in FIG. 1, to each of a plurality of user terminals 30, 30, . . . , a related information providing server 10 as the related information providing apparatus of the present embodiment provides related information (hereinafter, also referred to as a second content) relating to a broadcast program (hereinafter, also referred to as a first content) displayed by that user terminal 30, 30, . . . , through a network N.

The network N is connected with search apparatuses 50, a broadcast station 60 for broadcasting a broadcast program to the user terminals 30, 30, . . . , and an Electronic Program Guide distribution station 70 for providing Electronic Program Guide information to the user terminals 30, 30, . . . , as well as the related information providing server 10 and the user terminals 30, 30, . . . .

Each user terminal 30 is a two-way communication television, which can receive an electric wave from the broadcast station 60 or the Electronic Program Guide distribution station 70, display a broadcast program or Electronic Program Guide information and make some reply to the broadcast station 60 through the network N. This user terminal 30 comprises: a control part 31 for performing various control processes; a receiver 41 for receiving an electric wave from the broadcast station 60 or the Electronic Program Guide distribution station 70; a display device 42; a user radio operation terminal 44; a user interface 43 for receiving a signal from the radio operation terminal 44; and a network interface 49 for communicating with the related information providing server 10 or the like through the network N. The control part 31 comprises: a CPU 32 for executing various kinds of processing; a RAM 37 used, for example, as a work area for the CPU 32; a ROM 38 for previously storing various kinds of data, programs and the like; and an external storage 39 such as a hard disk drive. From the functional viewpoints, the CPU 32 comprises: a display control part 33 for making the display device 42 display data or the like obtained through the receiver 41 or the network interface 49; and a communication control part 34 for controlling communication with the broadcast station 60 or the related information providing server 10 through the network N. Each of these functional parts 33 and 34 functions when the CPU 32 executes a program stored in the ROM 38.

The related information providing server 10 comprises: a CPU 11 for executing various kinds of processing; a work memory 20 used as a work area for the CPU 11; a ROM 21 storing various kinds of data and the like; an external storage 22 such as a hard disk drive; a cache memory 28; and a network interface 29.

The external storage 22 stores, in advance, programs 24 to be executed by the CPU 11. Further, in the external storage 22, a related information table 23 is set for storing related information of broadcast programs. Although not shown, the external storage 22 further stores communication addresses and the like of the search apparatuses 50, 50, . . . and the Electronic Program Guide distribution station 70. In the cache memory 28, a related information table 28c is set for storing related information of broadcast programs for a predetermined period of time. From the functional viewpoints, the CPU 11 comprises: a meta-information collection part 12 for collecting Electronic Program Guide information (meta-information) of each broadcast program from the Electronic Program Guide distribution station 70; a keyword extraction part 13 for extracting keywords from meta-information; a related information acquisition part 14 for acquiring related information, which includes a keyword relating to a broadcast program, from a search apparatus 50; and a related information providing part 15 for providing related information to a user terminal 30. Each of these functional parts 12-15 functions when the CPU 11 executes a program 24 stored in the external storage 22.

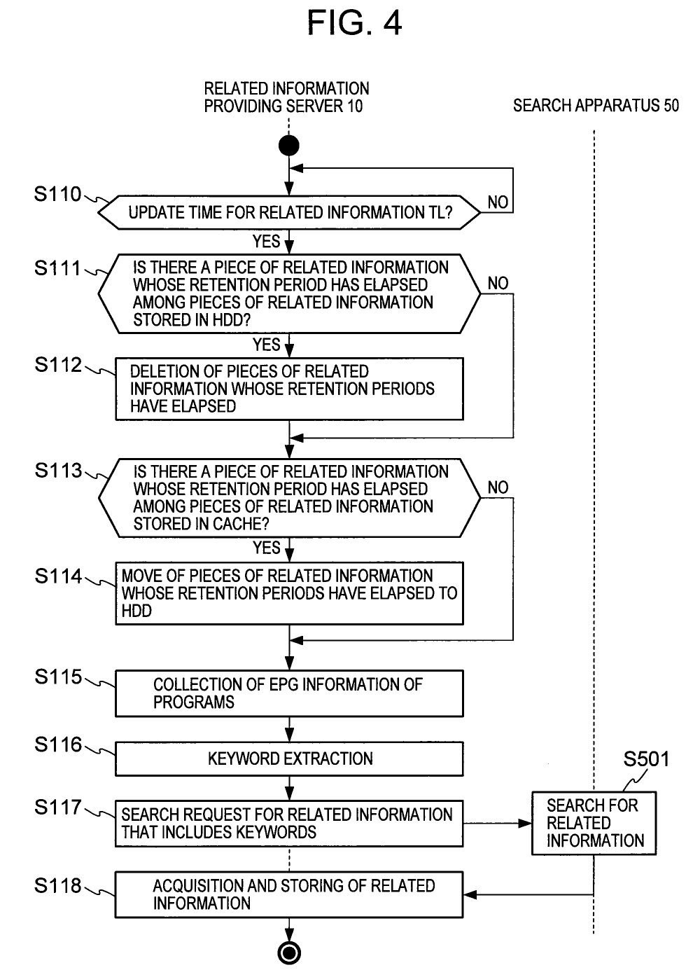

Next, referring to FIG. 4, processing in the related information providing server 10 for periodically acquiring related information will be described.

The related information acquisition part 14 of the related information providing server 10 judges whether it is a time to update the related information tables 23, 28c (S110). As the time to update, 00:00 every day may be considered, for example. If it is the time to update, it is judged whether there is a piece of related information whose retention period has elapsed among the pieces of related information stored in the related information table 23 of the external storage 22 (S111). If there is a piece of related information whose retention period has elapsed, that piece of related information is deleted (S112), and the flow proceeds to the step S113. On the other hand, if there is no piece of related information whose retention period has elapsed, the flow immediately goes to the step S113. In the step S113, it is judged whether there is a piece of related information whose retention period has elapsed among the related information stored in the related information table 28c of the cache memory 28. If there is a piece of related information whose retention period has elapsed, that piece of related information is moved to the related information table 23 of the external storage (S114), and the flow proceeds to the step S115. On the other hand, if there is no piece of related information whose retention period has elapsed, the flow immediately goes to the step S115.

In the step S115, the meta-information collection part 12 establishes a communication line with the Electronic Program Guide distribution station 70 by using the communication address of the Electronic Program Guide distribution station 70 stored in the external storage 22, collects Electronic Program Guide information of broadcast programs to be broadcast in the future, as meta-information of those broadcast programs, and stores the meta-information temporarily in the work memory 20.

When the meta-information (Electronic Program Guide information) of the broadcast programs has been collected, the keyword extraction part 13 extracts characteristic keywords such as personal names, place-names, product names or the like from the meta-information stored in the work memory 20 by using various dictionaries, and stores the extracted keywords in the work memory 20 (S116).

Here, Electronic Program Guide information of a broadcast program and keywords extracted from the Electronic Program Guide information will be described simply.

As shown in FIG. 3 for example, Electronic Program Guide information as meta-information has the title of a broadcast program, the channel of the broadcast program, the broadcast date, an abstract of the broadcast program, and the like. When keywords are extracted from the Electronic Program Guide information, the title of the broadcast program and words and terms in the abstract are extracted as keywords. In this example, travel, Egypt, ruins, pyramid, sphinx, and the like are extracted as keywords.

When the keyword extraction part 13 extracts one or more keywords (S116), the related information acquisition part 14 establishes communication lines with a plurality of search apparatuses 50, 50, . . . successively by using the communication addresses of the search apparatuses 50, 50, . . . stored in the external storage 22, and requests each search apparatus 50 to search for related information that includes each of the one or more keywords stored in the work memory 20 (S117). At that time, considering the security, it is favorable to perform encryption of information and server authentication by using an encrypted communication technique such as Secure Socket Layer (SSL). These methods for securing the security are employed depending on the situation.

When a search apparatus 50 searches for related information by using a keyword included in the search request (S501) and holds the related information relating to the keyword, then the search apparatus 50 sends the related information to the related information providing server 10, i.e. the sender of the request for the search. Further, when the search apparatus 50 does not hold the related information relating to the keyword, the search apparatus 50 sends the Uniform Resource Locator (URL) of the site that holds the related information to the related information providing server 10 as the source of the request for the search. In that case, the related information providing server 10 uses the URL sent from the search apparatus 50 to access the site that holds the related information relating to the keyword, to acquire the related information.

When the related information is acquired from the search apparatus 50 or the site indicated by the search apparatus 50, the related information acquisition part 14 of the related information providing server 10 associates the related information with the keyword and stores them in the related information table 28c in the cache memory 28 (S118).

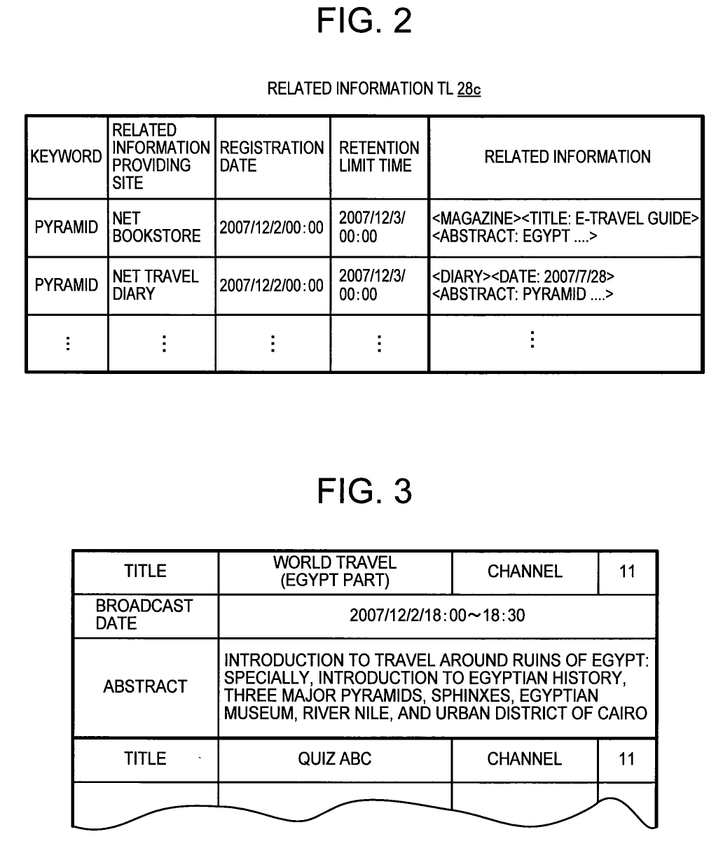

As shown in FIG. 2, the related information table 28c has: a keyword field for storing a keyword; a related information providing site field for storing a name of a site that provides the related information; a registration date field for storing the date of registration of the related information in the table 28c; a retention time limit field for storing a time limit of retaining the related information in the table 28c; and a related information field for storing the related information. In the example shown in FIG. 2, when “pyramid” is extracted as a keyword from the piece of Electronic Program Guide information having the title “World Travel (Egypt part)” among the pieces of Electronic Program Guide information shown in FIG. 3, then “pyramid” is stored in the keyword field; “Net bookstore” in the related information providing site field; “2007/12/2/00:00”, the date as the present time, in the registration date field; “2007/12/3/00:00”, the date twenty-four hours from the present time, in the retention time limit field; and the related information of “pyramid” in the related information field.

When the elapse of the retention period of the related information is judged in the steps S111 and S113, the retention time limit fields of the related information tables 23, 28c are referred to. However, the retention period of related information stored in the related information table 28c in the cache memory 28 is one day as described above, while the retention period of related information stored in the related information table 23 in the external storage 22 is, for example, one week. Accordingly, when a record of related information stored in the related information table 28c in the cache memory 28 is moved in the step S114 to the related information table 23 in the external storage 22, the retention time limit stored in the retention time limit field becomes one week after the date of the movement, although the data in the record are copied basically as they are.

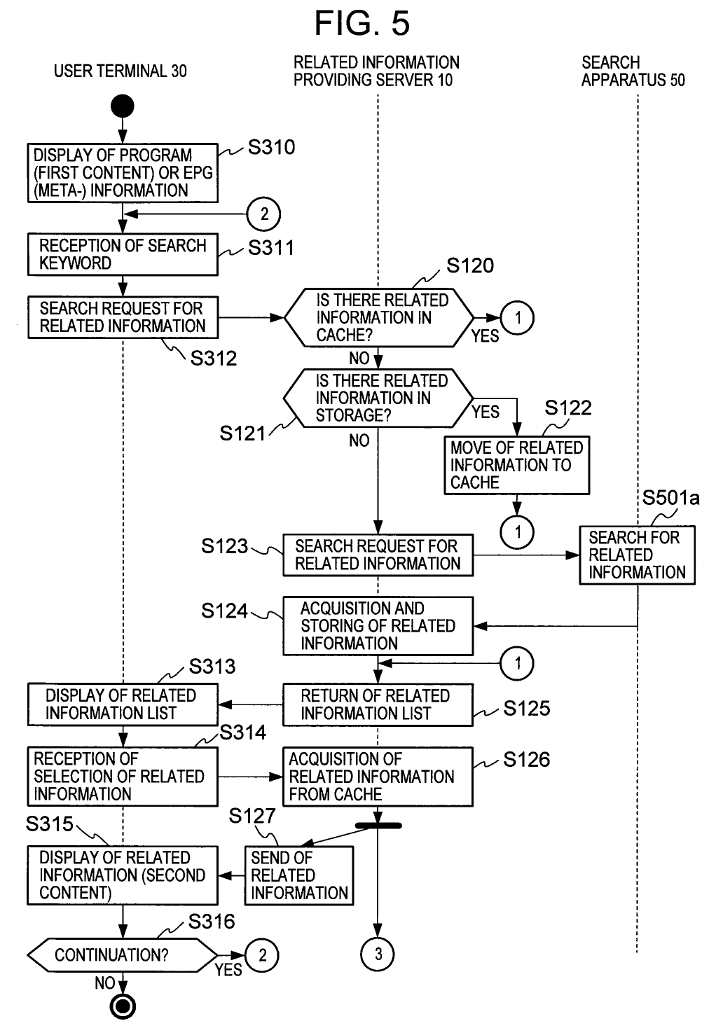

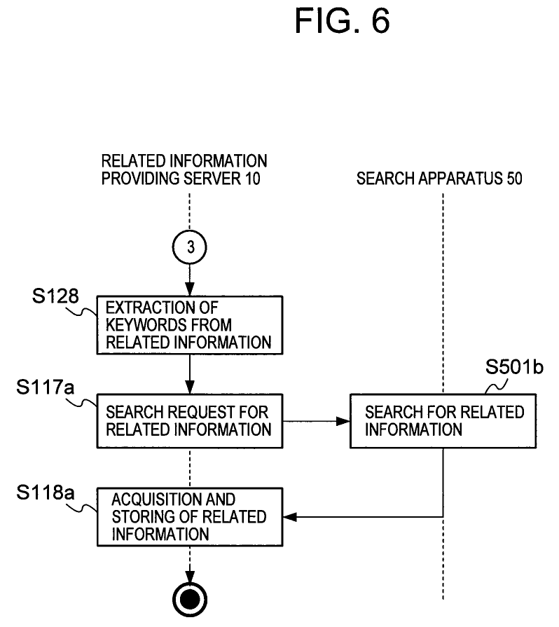

Next, according to the sequence diagrams shown in FIGS. 5 and 6, will be described processing by a user terminal 30 from request for related information until acquisition of the related information, and processing by the related information providing server 10 for providing related information.

When a user terminal 30 receives a keyword as a result of user's operation of the radio operation terminal 44 (S311) while a broadcast program or Electronic Program Guide information is displayed (S310), the user terminal 30 sends a search request including the keyword to the related information providing server 10 (S312). At that time, the communication control part 34 of the user terminal 30 establishes a communication line with the related information providing server 10 by using the communication address (which is previously stored in the external storage 39) of the related information providing server 10, to send the search request to the related information providing server 10.

Receiving the search request including the keyword from the user terminal 30 to search for related information, the related information providing part 15 of the related information providing server 10 judges whether the keyword field of the related information table 28c in the cache memory 28 stores the keyword included in the search request, i.e. whether the related information table 28c stores related information that includes the keyword (S120). When such related information is stored, the flow proceeds to the step S125. On the other hand, when such related information is not stored, the related information providing part 15 judges whether the related information table 23 in the external storage 22 stores related information as the target (S121). When such related information is stored in the related information table 23 in the external storage 22, the related information is moved to the related information table 28c in the cache memory 28 (S122), and the flow proceeds to the step S125. Here, when the record of the related information is moved to the related information table 28c in the cache memory 28, the retention time limit stored in the retention time limit field becomes one day after the date of the movement, although the data in the record are copied basically as they are.

When the related information providing part 15 judges in the step S121 that the target related information is not stored in the related information table 23 in the external storage 22, the related information acquisition part 14 sends a request for related information that includes the keyword to a search apparatus 50, similarly to the step S117 (S123). In response to this, the search apparatus 50 returns a search result (the related information or the URL of the site that holds the related information) to the related information providing server 10 that has sent the request, similarly to the step S501 (S501a). Thus, the related information acquisition part 14 of the related information providing server 10 acquires the related information, and then stores the related information in the related information table 28c in the cache memory 28 similarly to the step S118 (S124).

When the related information providing part 15 judges in the step S120 that the cache memory 28 stores the target related information, or when it moves the target related information to the cache memory 28 in the step S122, or when the related information acquisition part 14 stores the target related information in the cache memory in the step S124, then the related information providing part 15 generates a related information list by referring to the related information table 28c in the cache memory, and sends the related information list to the user terminal 30 that has sent the search request (S125). Here, the related information list is, for example, a list of titles of magazines and the like included in the related information.

When the communication control part 34 of the user terminal 30 receives the related information list, the communication control part 34 delivers the related information list to the display control part 33 to make the related information list displayed on the display device 42 (S313). Then, when designation of one or more pieces of related information is received as a result of user's operation of the radio operation terminal 44, the communication control part 34 request the related information providing server 10 to send the related information in question (S314).

When the request for sending of the specific piece of related information is received from the user terminal 30, the related information providing part 15 acquires the specific piece of related information from the related information table 28c in the cache memory 28 (S126), and sends that piece of related information to the user terminal 30 as the requester (S127).

When the communication control part 34 of the user terminal 30 receives the related information from the related information providing server 10, the communication control part 34 delivers it to the display control part 34 to make the related information displayed on the display device 42 (S315). After this, if the user of the user terminal 30 does not intend to continue his operation, a series of processes is ended. On the other hand, if the user wants to inquire into the displayed related information still more, the flow proceeds to the step S311.

Further, in the step S126, in parallel with the acquisition of the specific piece of related information by the related information providing part 15 from the related information table 28c in the cache memory 28 (S126) and sending of the acquired piece of related information to the user terminal 30 as the requester (S127), the keyword extraction part 13 extracts a keyword from that specific piece of related information (S128 in FIG. 6). After that, similarly to the above steps S117 and S118, the related information acquisition part 14 sends a search request for related information that includes this keyword to the search apparatus 50 (S117a), and a search is made in this search apparatus 50 (S501b), and the search apparatus 50 acquires related information as a search result and stores the acquired related information in the related information table 28c in the cache memory 28 (S118a).

As described above, in the present embodiment, the newest related information is collected from Electronic Program Guide information before a search request for related information of a broadcast program is received from a user terminal 30, and the collected related information is stored in the cache memory 28. As a result, it is highly possible that related information for which a user makes a search request is stored in the cache memory 28 of the related information providing server 10, and the related information can be provided to the user very quickly and efficiently. In other words, a portal service operating company that operates the related information providing server 10 can provide an effective Mash Up service very quickly. Of course, the portal service operating company can provide a Mash Up service also when it provides a content delivery service such as a Video On Demand service.

Further, in the present embodiment, even when a user records a broadcast program and plays back the program few days after the broadcast of the program, it is highly possible that related information for which the user makes a search request is stored in the external storage 22 of the related information providing server 10. Thus, the related information can be provided to the user more efficiently in this case than in the case where a search request is sent to a plurality of search apparatuses 50, 50, . . . . However, in this case, the related information stored in the external storage 22 is provided to the user, and surely it takes more time to respond to the user in comparison with the case where the related information is previously stored in the cache memory 28. Thus, a second embodiment will be described in the following. In the second embodiment, related information can be provided very quickly even when a user records a broadcast program and plays back the broadcast program few days after and makes a search request for related information of the recorded broadcast program.

### Second Embodiment

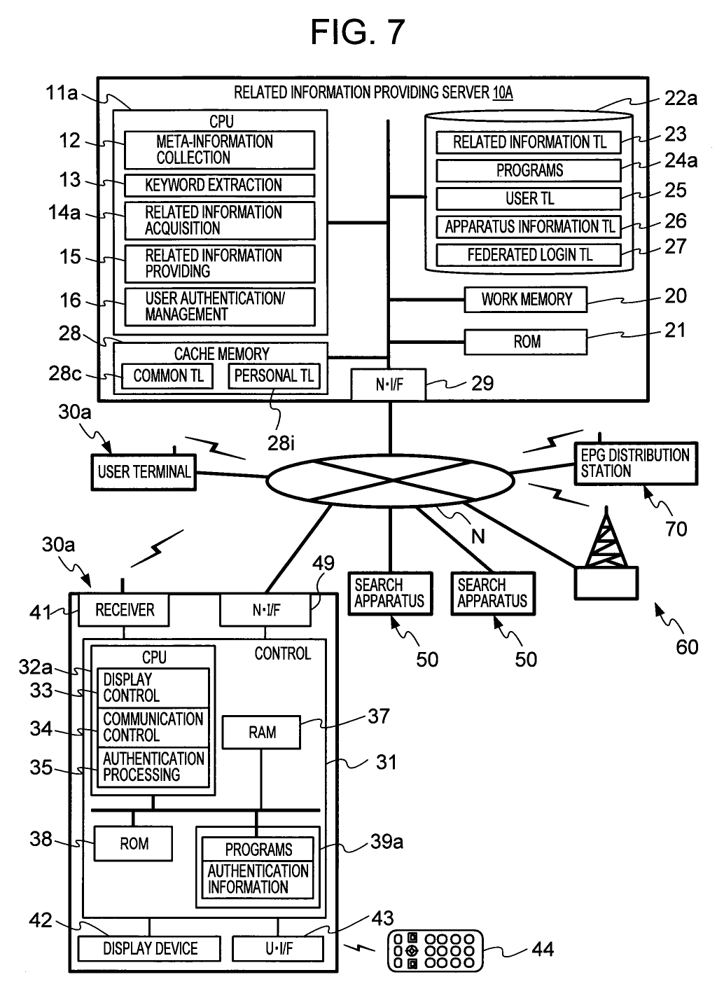

A second embodiment of related information providing apparatus according to the present invention will be described referring to FIGS. 7-12.

Similarly to the first embodiment, a related information providing server 10a of the present embodiment also comprises, as shown in FIG. 7: a CPU 11a for executing various kinds of processing; a work memory 20 used as a work area for the CPU 11a; a ROM 21 storing various kinds of data and the like; an external storage 22a such as a hard disk drive; a cache memory 28; and a network interface 29.

From the functional viewpoints, the CPU 11a comprises a meta-information collection part 12, a keyword extraction part 13, a related information acquisition part 14a and a related information providing part 15 similarly to the first embodiment, and further a user authentication/management part 16. The related information acquisition part 14a is slightly different in operation from the related information acquisition part 14 of the first embodiment, as described later. Each of these functional parts 12, 13, 14a, 15 and 16 functions when the CPU 11a executes a program 24a stored in the external storage 22a.

The cache memory 28 stores a personal related information table 28i that stores related information for each user, in addition to a common related information table 28c that is same as the related information table 28c in the first embodiment.

The external storage 22a previously stores programs 24a to be executed by the CPU 11a. Further, in the external storage 22a, a related information table 23a is set for storing related information of broadcast programs. Further, the external storage 22a stores a user table 25 for storing information on respective users of user terminals 30a, 30a, . . . , an apparatus information table 26 for storing information on the user terminals 30a, 30a, . . . , and a federated login table 27 for storing information used for logging in to a search apparatus 50 in place of a user.

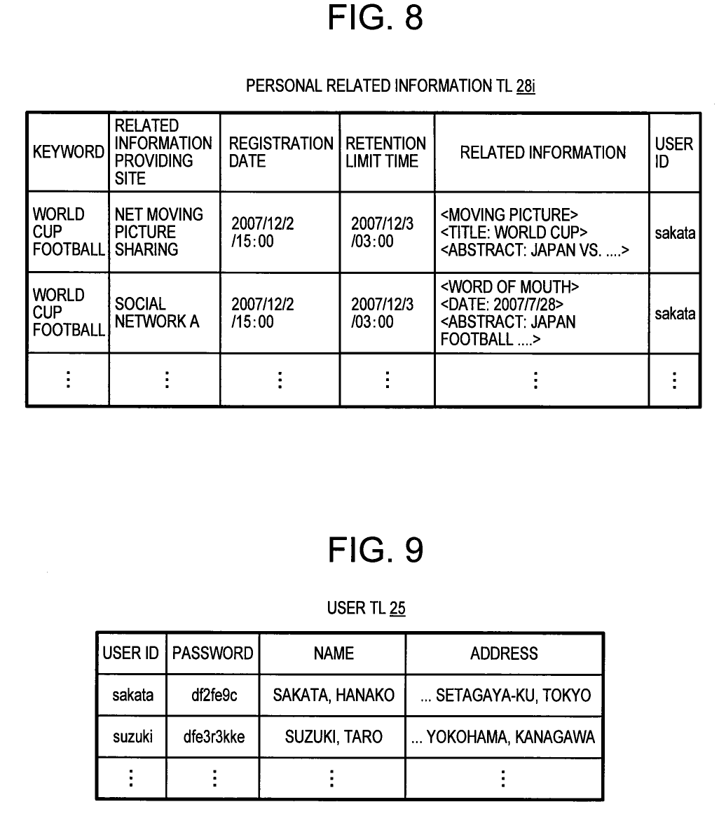

As shown in FIG. 8, the personal related information table 28i set in the cache memory 28 has a keyword field, a related information providing site field, a registration date field, a retention time limit field and a related information field similarly to the related information table 28c of the first embodiment or the common related information table 28c of the present embodiment, and further a user ID field for storing a user ID of a user terminal 30a.

As shown in FIG. 9, the user table 25 set in the external storage 22 has a user ID field for storing the ID of a user, a password field for storing the password of the user, a name field for storing the name of the user, and an address field for storing the address of the user.

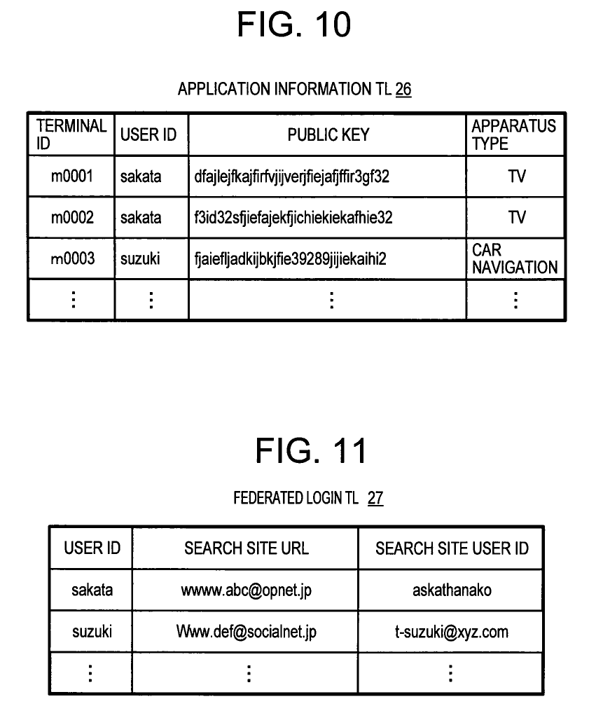

As shown in FIG. 10, the apparatus information table 26 set in the external storage 22a has a terminal ID field for storing the ID of a user terminal 30a, a user ID field for storing the ID of the user of the user terminal 30a, a public key field for storing a public key used for authenticating a signature by the user, and an apparatus type field for storing the apparatus type of the user terminal 30a.

As shown in FIG. 11, the federated login table 27 set in the external storage 22a has a user ID field for storing the ID of a user, a search site URL field for storing the URL of a search apparatus 50 designated by the user, i.e. the URL of a search site, and a search site user ID field for storing the user ID for the search site.

As for the tables 25, 26 and 27, i.e. the tables other than the related information table 23 among the tables 23, 25, 26 and 27 set in the external storage 22a, data of each field is inputted when a user registers with the related information providing server 10a in order to acquire related information from the related information providing server 10a.

As shown in FIG. 7, also each user terminal 30a has a hardware configuration that is basically same as that of the user terminal of the first embodiment. However, the CPU 32a has an authentication processing part 35 as it function, in addition to the functions of the CPU 32 in the first embodiment. Similarly to the other functions, the authentication processing part 35 functions when the CPU 32a executes a program stored in the ROM 38. Further, an external storage 39a stores broadcast programs similarly to the first embodiment, and further authentication information of the user terminal 30a. Here, the authentication information is the user ID, the terminal ID or the like, and the authentication information is stored at the time of the registration with the related information providing server 10a.

Next, operation of the related information providing server 10a, a user terminal 30a and a search apparatus 50 in the present embodiment will be described.

In the present embodiment also, the related information providing server 10a performs related information collection processing basically according to the procedure shown by the flowchart of FIG. 4 similarly to the first embodiment. In this case, in the step S118, the related information is stored in the common related information table 28c. Further, also when a search request for related information is received from a user terminal 30a in the course of broadcasting a program or immediately after broadcasting, the related information is provided to the user terminal 30a similarly to the first embodiment according to the procedure shown by the flowchart of FIGS. 5 and 6. In this case, in the step S126, the related information is acquired from the common related information table 28c.

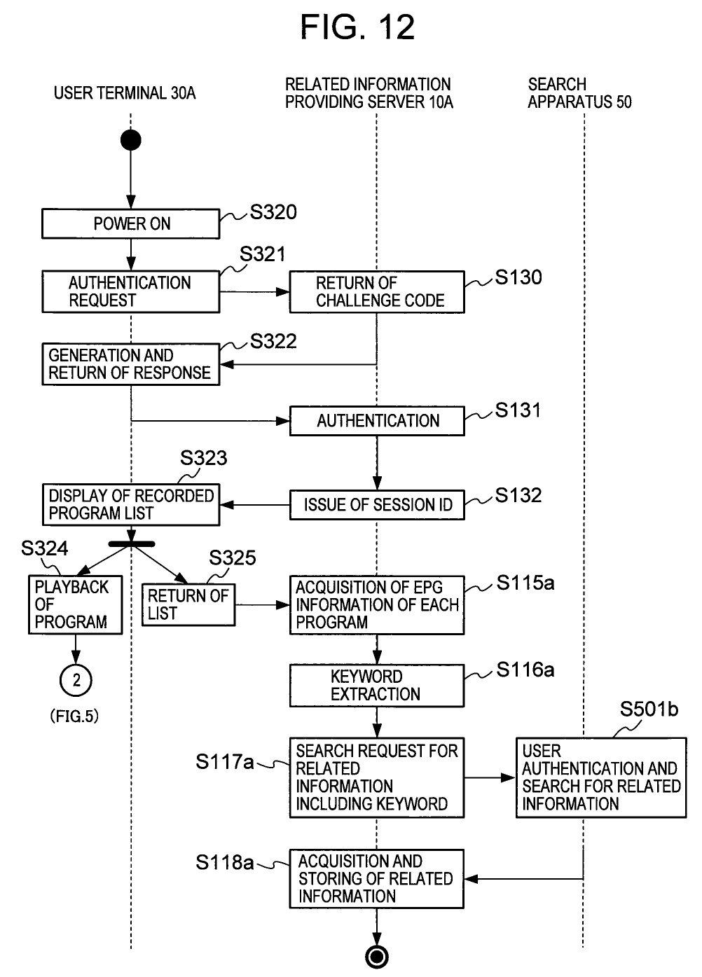

Next, according to the sequence diagram shown in FIG. 12, will be described processing by a user terminal 30a from request for related information until acquisition of the related information, and related information providing processing by the related information providing server for providing related information of a recorded broadcast program.

When a user terminal 30a is turned on (S320), immediately the authentication processing part 35 is activated and sends an authentication request to the related information providing server 10a (S321). In response to this, the user authentication/management part 16 of the related information providing server 10 generates a one time challenge code of a random character string in preparation for authentication, and returns the generated code to the user terminal 30a as the source of the authentication request (S130). The authentication processing part 35 of the user terminal 30a signs the one time challenge code by using a secret key in the authentication information stored in the external storage 39a. Then, the authentication processing part 35 sends the signed one time challenge code together with the user ID, the password and the terminal ID in the authentication information stored in the external storage 39a to the related information providing server 10a (S322). Here, although the secret key is stored in the external storage 39a, it is favorable that the secret key is stored in an object whose security is secured such as a tamper resistant chip. Receiving these, the user authentication/management part 16 of the related information providing server 10a acquires the public key corresponding to the terminal ID from the apparatus information table 26 (FIG. 10), and uses the public key to authenticate the signed value and the like sent from the user terminal 30a (S131). In this authentication, the user table 25 is referred to in order to ascertain whether the password corresponding to the user ID is the previously-registered password. When the authentication is successful, the user authentication/management part 16 issues a session ID for identifying the authentication session to the user terminal 30a (S132). This session ID is effective in the session before the user terminal 30a is turned off, for example. On the other hand, when the authentication ends in failure, the user authentication/management part 16 sends error information to the user terminal 30a, to make the user terminal 30a request authentication again.

When the user terminal 30a receives the session ID and thereafter the display control part 33 of the user terminal 30a displays a recorded broadcast program list on the display device 42 according to user's operation of the radio operation terminal 44 (S323), the communication control part 34 sends the recorded broadcast program list to the related information providing server 10a (S325). Further, in parallel with this, when an instruction to play back a specific broadcast program in the recorded broadcast program list is received as a result of user's operation of the radio operation terminal 44, the display control part 33 plays back the designated recorded broadcast program (S324), and the flow proceeds to the step S311 shown in the flowchart of FIG. 5. Further, also when the user terminal 30a receives the session ID and thereafter the display control part 33 of the user terminal 30a displays not the recorded broadcast program list (S323) but a broadcast program on the air or Electronic Program Guide information according to user's operation of the radio operation terminal 44, the flow proceeds to the step S311 shown in the flowchart of FIG. 5. Here, it is assumed that broadcast programs are recorded in the external storage 39 built in the user terminal 30a. However, broadcast programs may be recorded in a dedicated recorder coupled to the user terminal 30a.

When the recorded broadcast program list is received from the user terminal 30a (S325), the meta-information collection part 12 of the related information providing server 10a acquires respective pieces of Electronic Program Guide information of the broadcast programs indicated in the recorded broadcast program list among the pieces of Electronic Program Guide information stored in the external storage 22a, and expands the acquired pieces of Electronic Program Guide information on the work memory 20 (S115a). Here, the meta-information collection part 12 acquires pieces of Electronic Program Guide information from the external storage 22a. Thus, in the step S115 shown in FIG. 4, once the meta-information collection part 12 acquires Electronic Program Guide information from the Electronic Program Guide distribution station 70, the meta-information collection part 12 stores the acquired Electronic Program Guide information in the external storage 22a. Although the Electronic Program Guide information stored in the external storage 22a is used here, respective pieces of Electronic Program Guide information of broadcast programs indicated in the recorded broadcast program list may be acquired from the Electronic Program Guide distribution station 70 if the Electronic Program Guide distribution station 70 is arranged such that it can provide Electronic Program Guide information of past programs. Further, it is possible to make the user terminal 30a send the recorded broadcast program list together with respective pieces of Electronic Program Guide information of the programs indicated in the recorded broadcast program list, to use these pieces of Electronic Program Guide information.

When the meta-information collection part 12 receives the respective pieces of Electronic Program Guide information of the programs indicated in the recorded broadcast program list (S115a), the keyword extraction part 13 extracts keywords from the meta-information (the Electronic Program Guide information) stored in the work memory 20 and stores the extracted keywords in the work memory 20 (S116a).

When the keyword extraction part 13 extracts one or more keywords (S116), the related information acquisition part 14a establishes communication lines with a plurality of search apparatuses 50, 50, . . . successively by using the communication addresses of the search apparatuses 50, 50, . . . stored in the external storage 22a, and requests each search apparatus 50 to search for related information that includes each of the one or more keywords stored in the work memory 20 (S117a). At that time, as for a membership-based search apparatus 50 that requires authentication for each user, the related information acquisition part 14a refers to the federated login table 27 (FIG. 11) to acquire the site URL and the search site user ID corresponding to the user ID of the sender of the recorded broadcast program list, accesses the search apparatus 50 indicated by the search site URL, and issues an authentication certificate including the search site user ID according to an already-known method such as Security Assertion Markup Language (SAML), to make a search request.

When the membership-based search apparatus 50 requiring authentication receives the search request together with the authentication certificate, the search apparatus 50 verifies the received authentication certificate. If the verification is successful, the search apparatus 50 carries out the search, and sends related information as a search result to the related information providing server 10a (S501a). When a search apparatus 50 that does not require authentication receives the search request, the search apparatus 50 carries out the search similarly to the step S501, and sends related information as a search result to the related information providing server 10a (S501a).

When the related information acquisition part 14a of the related information providing server 10 receives the related information from the search apparatus 50 or the like, the related information acquisition part 14a associated the related information with the keyword, and stores them in a record of the corresponding user ID in the personal related information table 28i in the cache memory 28 (S118a).

After this, the related information providing server 10a provides related information that includes a keyword designated by a user to the terminal 30a of the user, according to the flowchart shown in FIG. 5. However, in the step S120 in the flowchart of FIG. 5, the related information providing part 15 judges which of the common related information table 28c in the cache memory 28 and the record of the corresponding user ID in the personal related information table 28i stores related information including the keyword.

As described above, in the present embodiment, the personal related information table 28i storing related information for each registered user is set in the cache memory 28. When a registered user records a broadcast program, the related information of the recorded broadcast program is stored in the personal related information table 28i in the cache memory 28. As a result, even when a user records a broadcast program, plays back the recorded broadcast program few days later, and makes a search request for the related information of the recorded broadcast program, it is possible to provide the related information very quickly.

Further, in the present embodiment, user authentication processing is performed, and, in the case of a membership-based search site, federated login is performed to search for a membership-based content. As a result, it is possible to provide related information safely.

In the present embodiment, when the user terminal 30a displays the recorded broadcast program list (S323), the related information providing server 10a acquires respective pieces of Electronic Program Guide information of the broadcast programs in the list and, further, respective pieces of related information of the broadcast programs. However, the related information providing server 10a may acquire respective pieces of Electronic Program Guide information of the programs in the list and, further, respective pieces of related information of the programs when the user terminal 30a starts playing back a recorded broadcast program or when the user terminal 30a records a broadcast program.

### Third Embodiment

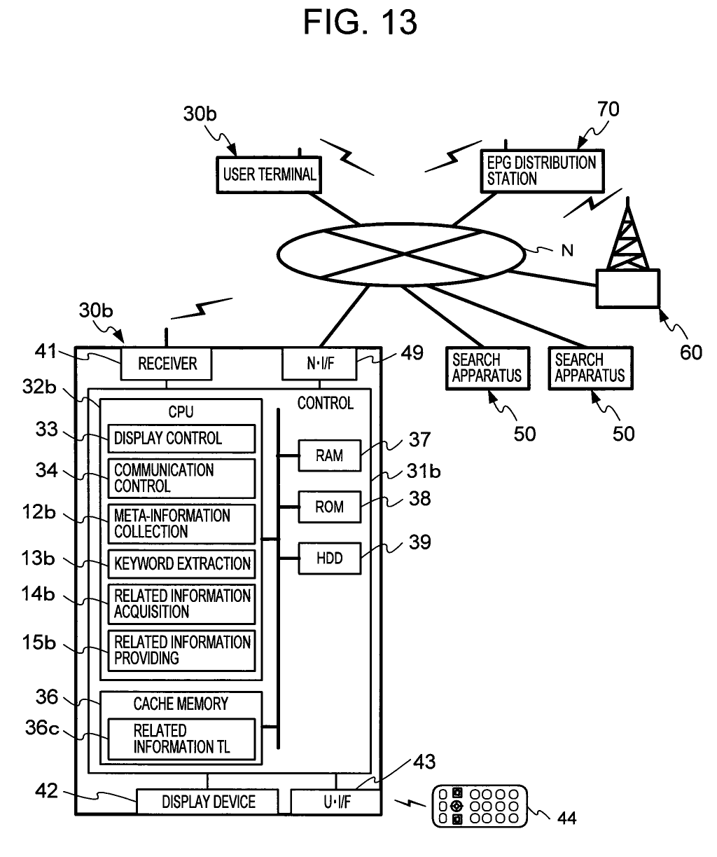

A third embodiment according to the present invention will be described referring to FIGS. 13-15.

In each of the above embodiments, the related information providing server 10, 10a provides related information to a user through the user terminal 30, 30a. As shown in FIG. 13, in the present embodiment, a user terminal 30b acquires related information and provides the acquired related information to the user. Thus, in the present embodiment, there is not a related information providing server 10, 10a of the above embodiments, and the functions of the related information providing servers 10, 10a in the above embodiments are built in each user terminal 30b. In other words, in the present embodiment, a user terminal 30b becomes a related information providing apparatus.

Similarly to the above embodiments, each user terminal 30b of the present embodiment also comprises a control part 31b for various kinds of control, a receiver 41, a display device 42, a radio operation terminal 44, a user interface 43, and a network interface 49. The control part 31b comprises: a CPU 32b for executing various kinds of processing; a RAM 37b used, for example, as a work area for the CPU 32b; a ROM 38b for previously storing various kinds of data, programs and the like; an external storage 39 such as a hard disk drive; and a cache memory 36.

From the functional viewpoints, the CPU 32 comprises a display control part 33 and a communication control part 34 similarly to the above embodiments, and, in addition, a meta-information collection part 12c for collecting Electronic Program Guide information (meta-information) of each broadcast program from an Electronic Program Guide distribution station 70, a keyword extraction part 13c for extracting keywords from meta-information, a related information acquisition part 14c for acquiring related information, which includes a keyword relating to a broadcast program, from a search apparatus 50, and a related information providing part 15c for delivering related information to the display control part 33. Each of these functional parts 33, 34, 12c, 13c, 14c and 15c functions when the CPU 32c executes a program stored in the ROM 38.

In the cache memory 36, a related information table 36c is set for storing related information of a broadcast program for a predetermined period of time. The data structure of the related information table 36c is basically same as the related information table 28c of the first embodiment, which has described referring to FIG. 2.

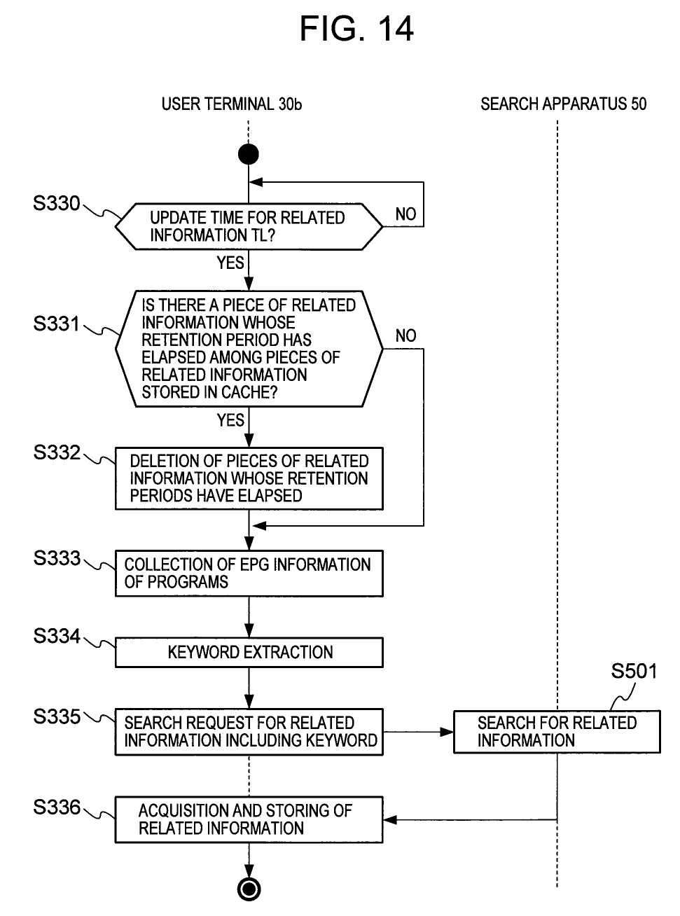

Next, according to the sequence diagram shown in FIG. 14, periodic processing by a user terminal 30b for collecting related information will be described. This related information collection processing is basically same as the processing by the related information providing server 10 in the first embodiment described referring to FIG. 4, and thus the processing will be described simply in the following.

The related information acquisition part 14b of a user terminal 30b judges whether it is a time to update the related information table 36c in the cache memory 36 (S330). If it is the time to update, it is judged whether there is a piece of related information whose retention period has elapsed among the pieces of related information stored in the related information table 36c (S331). If there is a piece of related information whose retention period has elapsed, that piece of related information is deleted (S332), and the flow proceeds to the step S333. On the other hand, if there is no piece of related information whose retention period has elapsed, the flow immediately goes to the step S333.

In the step S333, the meta-information collection part 12 establishes a communication line with the Electronic Program Guide distribution station 70 by using the communication address of the Electronic Program Guide distribution station 70, collects Electronic Program Guide information of broadcast programs to be broadcast in the future, as meta-information of those broadcast programs, and stores the meta-information temporarily in the RAM 37 as a work memory and in the external storage 39 also.

When the meta-information (Electronic Program Guide information) of the broadcast programs has been collected, the keyword extraction part 13b extracts keywords from the meta-information stored in the RAM 37, and stores the extracted keywords in the RAM 37 (S334).

When the keyword extraction part 13b extracts one or more keywords (S334), the related information acquisition part 14b establishes communication lines with a plurality of search apparatuses 50, 50, . . . successively by using the communication addresses of the search apparatuses 50, 50, . . . stored in the external storage 39, and requests each search apparatus 50 to search for related information that includes each of the one or more keywords stored in the RAM 37 (S335).

Each search apparatus 50 searches for related information by using the keyword included in the search request (S501), and sends the related information as a search result to the user terminal 30b, i.e. the sender of the request for the search.

When the related information is acquired from the search apparatus 50 or a site indicated by the search apparatus 50, the related information acquisition part 14b of the user terminal 30b associates the related information with the keyword and stores them in the related information table 36c in the cache memory 36c (S336).

Here, it is assumed that the Electronic Program Guide information of all the programs broadcast by each broadcast station is collected, and the related information of all the broadcast programs is collected. However, this is a large load on a user terminal 30b owned by an individual person. Thus, it is possible that a user as an owner of a user terminal 30b previously inputs a genre of broadcast programs as objects of his appreciation, to store the genre in the external storage 39 or the like, and Electronic Program Guide information and related information of broadcast programs of this genre are collected.

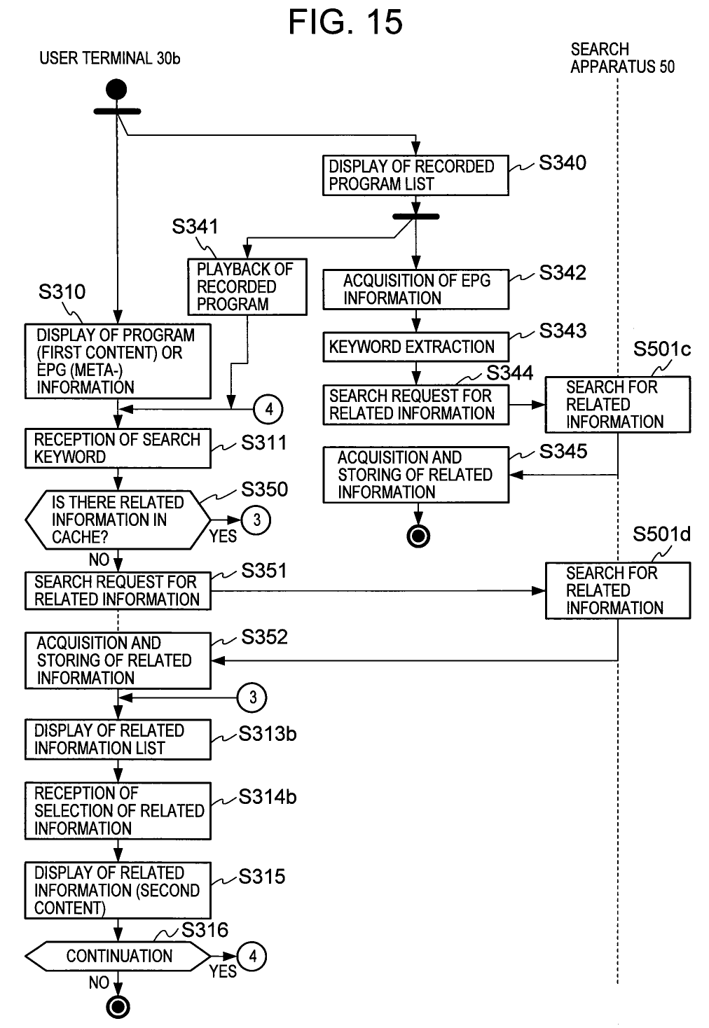

Next, according to the sequence diagram shown in FIG. 15, related information providing processing by a user terminal 30b will be described.

In response to user's operation of the radio operation terminal 44, the user terminal 30b displays a recorded broadcast program list, a broadcast program or Electronic Program Guide information (S340, S310). Here, it is assumed that a recorded broadcast program list is displayed (S340). In this case, when an instruction to play back a specific broadcast program in the recorded broadcast program list is received as a result of user's operation of the radio operation terminal 44, the display control part 33 plays back the designated recorded broadcast program (S341), and the flow proceeds to the step S312. In parallel with this, the meta-information collection part 12b of the user terminal 30b acquires the piece of Electronic Program Guide information of each broadcast program indicated in the recorded broadcast program list among the pieces of Electronic Program Guide information stored in the external storage 39, and stores the acquired pieces of Electronic Program Guide information in the RAM 37 (S342). Subsequently, the keyword extraction part 13b extracts keywords from the meta-information (Electronic Program Guide information) stored in the work RAM 37 similarly to the above step S116, and stores the extracted keywords in the RAM 37 (S343).

When the keyword extraction part 13b extracts one or more keywords (S343), the related information acquisition part 14b establishes communication lines with a plurality of search apparatuses 50, 50, . . . successively by using the communication addresses of the search apparatuses 50, 50, . . . stored in the external storage 39, and requests each search apparatus 50 to search for related information that includes each of the one or more keywords stored in the RAM 37 (S344). In the present embodiment too, an authentication certificate may be generated by using a federated login table as in the second embodiment so that a search request can be made to a membership-based search apparatus that requires authentication. The authentication certificate is issued to the search apparatus in question, and a search request is made to that search apparatus. When the search apparatus 50 receives the search request, the search apparatus 50 carries out search similarly to the step S501 in FIG. 4, and sends related information as a search result to the user terminal 30b, i.e. the source of the request (S501c). When the related information is acquired from the search apparatus 50 or the like, the related information acquisition part 14b of the user terminal 30b associates the related information with the keyword and stores them in the related information table 36c in the cache memory 36 (S345).

When a keyword is received as a result of user's operation of the radio operation terminal 44 (S311) in a state that the user terminal 30b is displaying a broadcast program or Electronic Program Guide information (S310) instead of displaying a recorded broadcast program list (S340) or the user terminal 30b is playing back a recorded broadcast program after display of a recorded broadcast program list (S341), then the related information providing part 15b judges whether related information that includes the keyword is stored in the related information table 36c in the cache memory 36 (S350). When such related information is not stored, the related information acquisition part 14b requests a plurality of search apparatuses 50, 50, . . . to search for related information that includes the keyword (S351). When a search apparatus 50 receives the search request, the search apparatus 50 carries out the search, and sends related information as a search result to the user terminal 30b, i.e. the source of the request (S501c). When the related information is acquired from the search apparatus 50 or the like, the related information acquisition part 14b of the user terminal 30b associates the related information with the keyword, and stores them in the related information table 36c in the cache memory 36 (S352), and the flow proceeds to the step S313b. When the related information providing part 15b judges in the step S350 that related information including the keyword is stored in the related information table 36c in the cache memory 36, the flow immediately goes to the step S313b.

In the step S313b, the related information providing part 15b delivers a related information list to the display control part 33, to make the display control part 33 display the list on the display device 42.

When the related information providing part 15b receives one or more pieces of related information in the related information list as a result of user's operation of the radio operation terminal 44 (S314b), the related information providing part 15b retrieves the one or more pieces of related information from the related information table 36c in the cache memory 36, to make the display control part 33 display the retrieved pieces of related information on the display device 42 (S315).

After this, if the user of the user terminal 30b does not intend to continue his operation, a series of processes is ended, similarly to the first embodiment. On the other hand, if the user wants to inquire into the displayed related information still more, the flow proceeds to the step S311.

In the present embodiment described above, it is necessary to increases the functions of a user terminal or the storage capacity of the external storage or the like, in comparison with the first and request a server 10, 10a for related information, and thus related information can be provided to a user more quickly.

In all the above embodiments, a user terminal receives broadcast programs and Electronic Program Guide information via radio waves. The present invention, however, is not limited to this. Of course, the present invention can be applied to the case where broadcast programs are received through a cable or the Internet.

In the above embodiments, Electronic Program Guide information is used as meta-information of a broadcast program. However, in the case where a broadcast program content can be acquired, it is possible that the broadcast program content is acquired to analyze the content, and meta-information added to the main part of the content is used.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A related information providing apparatus that provides related information of various contents provided to a user, comprising:
a meta-information collection means, which collects meta-information of the various contents;
a keyword extraction means, which extracts one or more keywords from the meta-information collected by the meta-information collection means;
a related information acquisition means, which uses, as a search key or search keys, the one or more keywords extracted by the keyword extraction means, to acquire related information that relates to the contents and includes the keywords;
a related information storing means, which stores the related information acquired by the related information acquisition means, in association with the keywords used for acquisition of the related information; and
a related information providing means, which, on receiving a related information request including one or more keywords relating, extracts related information associated with the keywords included in the related information request among related information stored in the related information storing means, and provides the extracted related information.

2. A related information providing apparatus of claim 1, wherein:
the various contents provided to the user are broadcast programs; and
the meta-information collection means collects Electronic Program Guide (Electronic Program Guide) information as the meta-information of the broadcast programs.

3. A related information providing apparatus of claim 1, wherein:
the keyword extraction means extracts one or more keywords from a second content that is the related information extracted by the related information providing means from the related information storing means; and
the related information acquisition means uses, as a search key or search keys, the one or more keywords extracted by the keyword extraction means to acquire related information that includes the keyword or keywords relating to the second content.

4. A related information providing apparatus of claim 1, wherein:
the related information storing means comprises a cache memory, and the cache memory stores one or more pieces of related information acquired by the related information acquisition means for a predetermined period of time.

5. A related information providing apparatus of claim 4, wherein:
the related information storing means comprises an external storage that stores the related information;
the related information acquisition means deletes a piece of related information for which the predetermined period has elapsed from the cache memory and stores the deleted piece of related information in the external storage among the one or more pieces of related information stored in the cache memory; and
the related information providing means provides a piece of related information stored in the cache memory when that piece of related information is related to the keywords included in the related information request and is stored in the cache memory, while the related information providing means searches storage contents of the external storage when that piece of related information is not stored in the cache memory, and provides that piece of related information when that piece of related information is stored in the external storage.

6. A related information providing apparatus of claim 1, wherein:
when a display terminal for displaying the various contents records a content and collects meta-information relating to the content, the meta-information collection means collects the meta-information of the content, being triggered by one event among recording of the content by the display terminal, displaying of a record list including the content by the display terminal, and playback of the content by the display terminal.

7. A related information providing apparatus of claim 1, wherein:
the related information providing apparatus further comprises a connection part with a network; and
the related information providing means: receives a related information request from the display terminal that displays the various contents, through the network and the connection part; and provides a piece of related information associated with keywords included in the related information request to the display terminal.

8. A related information providing apparatus of claim 6, wherein:
the related information providing apparatus further comprises a connection part with a network;
the related information storing means has a storage area for each of a plurality of display terminals;
when a specific display terminal among the plurality of display terminals records a content, the meta-information collection means receives information for specifying the content from the specific display terminal through the network and the connection part, and collects meta-information of the content on a basis of the received information;
when the related information acquisition means acquires related information of the content, the acquired related information is stored in the storage area assigned to the specific display terminal among the plurality of storage areas of the related information storing means; and
the related information providing means receives a related information request from the specific display terminal through the network and the connection part, and provides the related information stored in the storage area assigned to the specific display terminal to that specific display terminal.

9. A display terminal, wherein:
the display terminal comprises:
a related information providing apparatus of claim 1;
a display device for displaying the various contents and the related information; and
an operating means used for inputting a keyword; and
the related information providing means receives one or more keywords acquired by operation of the operating means from the operating means.

10. A related information providing method, in which related information of various contents provided to a user is provided by a computer, wherein the computer executes:
a meta-information collection step, in which meta-information of various contents is collected;
a keyword extraction step, in which one or more keywords are extracted from the meta-information collected in the meta-information collection step;
a related information acquisition step, in which the one or more keywords extracted in the keyword extraction step are used as search keys, to acquire related information that includes the keywords relating to a content, and the acquired related information is associated with the keywords and stored in a storage area of the computer; and
when a related information request including one or more keywords relating to a content is received, pieces of related information associated with the keywords included in the related information request are extracted among pieces of related information stored in the storage area, and the extracted pieces of related information are provided.
